(19) United States
(12) Patent Application Publication
(10) Pub. No.: US 2006/0188089 A1
(43) Pub. Date: Aug. 24, 2006

(54) Reduction in acoustic coupling in communication systems and appliances using multiple microphones

(76) Inventors: Eric J. Diethorn, Long Valley, NJ (US); Gary W. Elko, Summit, NJ (US)

Correspondence Address: BIRCH, STEWART, KOLASCH & BIRCH LLP, PO BOX 747, 8110 GATEHOUSE ROAD, STE 500 EAST, FALLS CHURCH, VA, 22040-0747, US

(21) Appl. No.: 11/060,782

(22) Filed: Feb. 18, 2005

(51) Int. Cl. H04M 9/08

(52) U.S. Cl. 379/406.01

(57) ABSTRACT

A system and method of digitally modeling and significantly reducing the direct coupling between a telephone appliance loudspeaker and microphone employs a handset microphone in a phone appliance, such as, for example, a speakerphone, as a reference channel along with the speakerphone microphone to reduce the direct coupling between the speakerphone loudspeaker and the speakerphone microphone. Using an analog adaptive echo cancellation scheme, the sensitivity and dynamic range of a telephone device microphone to speech from talkers in an enclosure but not from signals emitted by a telephone loudspeaker are enhanced. Nonlinear distortions produced by a telephone appliance loudspeaker are measured by a telephone appliance handset microphone and used in a feedback subsystem, e.g., network, to reduce nonlinear distortions in the telephone appliance loudspeaker and loudspeaker driving circuit.

### FIELD OF THE INVENTION

This invention is directed, in general, to acoustic coupling in communication systems and apparatus, and more particularly to reduction of direct coupling of a speakerphone loudspeaker to a speakerphone microphone.

### BACKGROUND OF THE INVENTION

Speech typically results in reflected waves. When the reflected wave arrives a very short time after a direct sound, it is perceived as a spectral distortion or reverberation. However, when the reflection arrives a few tens of milliseconds (ms) after the direct sound (i.e., a relatively long period of time), it is heard as a distinct echo. Such echoes may be annoying, and under extreme conditions can completely disrupt a conversation.

Acoustic echoes typically occur in telecommunications networks due to acoustic coupling between, for instance, a loudspeaker and a microphone (e.g., in a speakerphone). During a teleconference, where two or more parties are connected by a full-duplex link, an acoustic reflection of the far-side talker through the near-side conference room is returned to the far-side talker as an echo. Acoustic echo cancellation tends to be more difficult than network line echo cancellation since the duration of the acoustic echo is usually several times longer (100-400 ms) than typical electrical line echoes (20 ms). In addition, the acoustic echo may change rapidly at any time due to opening doors, moving persons, changing temperatures, etc., within the conference room. In other words, environmental factors may tend to exacerbate the acoustic echo heard through such devices making them more problematic to offset than their line echo counterparts.

In any speakerphone appliance, the speakerphone's microphone picks-up sound produced by the speakerphone's loudspeaker. In order to prevent or reduce the chances of the far-end caller at the other end from hearing echoes of his/her own speech, the speakerphone algorithm, which controls the loudspeaker and microphone, operates to disable or sufficiently attenuate the microphone's signal path to the loudspeaker when sound is emanating from the loudspeaker. To reduce the need to attenuate the microphone's signal, and thereby improve the subjective performance of the speakerphone, current state-of-the-art “full-duplex” speakerphones employ adaptive digital filters to model the loudspeaker-to-microphone acoustic path and digitally subtract the modeled echo from the microphone path before it is transmitted back to the far-end part.

Echo cancellers are used to cancel acoustic echoes. Typically, single-path echo cancellers include an adaptive filter and a subtractor. In operation, an incoming signal, for example in a conventional speakerphone, is received from a far-side talker and is heard through a speaker by a near-side talker. Unfortunately, the incoming signal is also received through the near-side microphone, which is typically positioned close to the near-side speaker. The incoming signal heard back through the near-side microphone results in an acoustic echo, which is then heard by the far-side talker. To combat this echo, the incoming signal is also applied to the adaptive filter when it first enters the echo canceller; the adaptive filter generates a replica signal of the incoming signal heard by the microphone in an attempt to model the echo signal. To accomplish this, the replica signal and the intended outgoing microphone signal, which includes the echo signal, are applied to the subtractor. The subtractor subtracts the replica signal from the outgoing microphone signal in an effort to eliminate or “cancel” the echo signal.

The resulting signal, after the cancellation, is called an error signal, since it may be analyzed to determine how much of the echo signal remains after cancellation. The error signal is fed back to the adaptive filter, which adjusts its internal filter coefficients in order to maximize cancellation of the echo signal and minimize the error signal. In this manner, the filter coefficients converge (hence, an “adaptive” filter) toward values that optimize the replica signal in order to cancel, at least as much as possible, the echo signal.

The use of a short analog canceller to increase dynamic range in telephone appliances is shown, for example, in U.S. Pat. No. 6,147,979, entitled, “System and method for echo cancellation in a communication system,” and in U.S. Pat. No. 6,321,080, entitled, “Conference telephone utilizing base and handset transducers.”

The '979 patent provides an echo canceller for reducing an echo component in an analog output signal caused by cross coupling of an incoming received signal received at a communication unit with the outgoing analog output signal, comprising 1) a digital echo canceller for digitally processing the analog output signal after being converted to digital form to reduce the cross-coupling echo component before transmission from the communication unit, and 2) an analog echo canceller connected between the communication unit output and the digital echo canceller for analog reduction of the cross coupling echo component in the analog output signal when in analog form before digital processing by the digital echo canceller.

The analog echo canceller of the '979 patent includes means for generating an analog cancellation signal which is substantially the same as the acoustic coupling echo component in the analog output signal before digital processing by the digital echo canceller and means for combining the analog echo cancellation signal with the analog output signal to reduce the cross coupling echo component before digital processing by the digital echo canceller. The combining means produces an echo-reduced analog output signal and includes means interposed between the combining means and the digital echo canceller to automatically amplify the echo-reduced analog output signal to a level for substantially maximum resolution digitization of the echo reduced analog output signal. The means of automatic amplification includes a variable gain amplifier, means for setting the amplifier gain at a level below a digitization saturation level, means for training the analog echo canceller until maximum echo reduction is achieved and means for increasing the gain of the variable gain amplifier after training is completed to obtain maximum digital resolution during conversion. The gain increasing means includes means for monitoring the maximum magnitude of the echo-reduced analog output signal relative to a peak conversion level and means for automatically adjusting the gain to maintain a preselected rate of repetitive conversions substantially at the peak conversion level.

FIG. 4 of the '979 patent, which is the prior art FIG. 1 of this Application, includes digital filter components 96 and 98, another D/A converter 100 for converting the output signal from filter component 98 and a gain control component 102, all included within the digital signal processor 84, and a summing amplifier, or summing node, 104 and a variable gain input amplifier 106 and a variable gain output amplifier 105 which are discrete from the digital signal processor 84 and alternatively integral with the digital signal processor 84.

The digital echo canceller 86 digitally processes the analog output signal from microphone 78 and variable gain input amplifier 106 after it is converted to digital form by the A/D converter 92 to digitally reduce the residual cross coupling echo component before transmission from the digital echo canceller 86 by D/A converter 94 and variable gain output amplifier 105. However, the summing node 104 and variable gain input amplifier 106 of an analog echo canceller 109 are connected between the microphone output 80 and the digital echo canceller 86 for analog reduction of the cross coupling echo component in the analog output signal appearing on output 80 when in analog form before digital processing by the digital echo canceller 86.

The filter component 98 digitally filters the incoming signal from the A/D converter 88 to generate a digital cancellation signal which is converted to an analog cancellation signal by D/A converter 100 which is substantially the same as the acoustic cross coupling echo component in the analog output signal at output 80. The analog cancellation signal is the negative of the echo component and summing amplifier 104 combines by summing the analog echo cancellation signal at an input 105 with the analog output signal from microphone output terminal 80 to reduce the cross coupling echo component 26 before digital processing by the digital echo canceller 86.

After the echo component has been reduced, the gain control component 102 of the digital signal processor 84 controls the variable gain input amplifier 106 to automatically amplify the echo reduced analog output signal at the output of summing amplifier 104 to a level for substantially maximum resolution digitization of the echo reduced microphonic analog output signal on output terminal 80. The gain control component 102 automatically controls the variable gain output amplifier 105 to compensate for changes in gain in the variable gain input amplifier 106 to maintain a uniform gain through the system. This improved resolution also enhances operation of the digital echo canceller 86 in digitally removing any residual echo component remaining after analog cancellation for there are more bits available for digitization and improved resolution of the residual echo components.

In order to make the analog cancellation signal to be the same as the cross coupling echo component, it is necessary to digitally process the signals with the digital filter components 96 and 98. The cross coupling path from D/A converter 90, speaker 74 and microphone 78 to the output 112 of A/D converter 92 has a scaled digital impulse response represented by a(n) while the feedback path of the analog cancellation signal from D/A converter 100, summing amplifier 104 to the output 112 of A/D converter 92 also has a scaled impulse response represented by the function f(n).

In speakerphone appliances, the loudspeaker signal at the speakerphone microphone is very large and, as a result, can saturate the analog-to-digital converter servicing the speakerphone microphone. By performing some degree of analog echo cancellation, the signal level can be reduced prior to reaching the analog-to-digital converter. This is what happens in the '979 patent.

### SUMMARY OF THE INVENTION

The systems and methods according to the invention help to increase the performance of a speakerphone appliance by using a handset microphone of the speakerphone appliance to digitally model and significantly reduce the direct coupling of the speakerphone loudspeaker to the speakerphone microphone.

The systems and methods according to the invention use a simple, short-length adaptive filter to remove the direct coupling, which the handset microphone effectively measures. By doing so, the duplex performance of the speakerphone can be improved by increasing the accuracy of a double-talk detector used to detect when the near- and far-end talkers are speaking simultaneously.

The systems and methods according to the invention use the close proximity of the handset microphone to the speakerphone loudspeaker to allow measurements of nonlinear distortions produced by the loudspeaker when used at high volume settings. The systems and methods according to the invention use such measurements in a feedback network to reduce the nonlinear distortion in the loudspeaker and the loudspeaker driving circuit (amplifier clipping for instance), thereby improving sound quality at the loudspeaker.

The systems and methods according to the invention also use an analog adaptive cancellation scheme to increase the sensitivity and dynamic range of the microphone signal to speech from talkers in the room and not from signals emanated by the loudspeaker.

The systems and methods of the invention perform a degree of analog echo cancellation to reduce the signal level prior to an analog-to-digital converter using a speakerphone appliance handset microphone signal as a reference channel applied to an echo canceller.

The systems and methods of the invention use a linear filter to predict what the acoustic signal will be in a speakerphone appliance for the direct path from the loudspeaker to the speakerphone microphone to effectively use acoustic echo cancellation even in the presence of a distorted loudspeaker signal, that includes both amplifier distortion as well as loudspeaker distortion.

The systems and methods according to the invention also reduce distortion caused by chassis rattle and buzz, which is not handled by current acoustic echo cancellation schemes.

The systems and methods according to the invention adaptively measure the acoustic path from the handset to the speakerphone microphone. Moreover, because this path will not change much due to the fixed geometry of the speakerphone system, this acoustic path may be measured over a long period of time.

The systems and methods according to the invention use the predicted signal from the adaptive filter to generate a canceling signal that is converted to an analog signal.

The systems and methods of the invention use an analog subtraction circuit to reduce the direct coupling, sample this subtracted signal, and use this signal in an acoustic echo cancellation scheme to reduce the long tail echo of the room.

The systems and methods of this invention use the handset microphone to identify a linear path to the speakerphone microphone that allows for the cancellation of direct path energy, even from a signal that is distorted by the loudspeaker or associated electronics.

### BRIEF DESCRIPTION OF THE DRAWINGS

The foregoing advantageous characteristics and features of the systems and methods according to the invention will be explained in greater detail and others will be made apparent from the detailed description of the exemplary embodiments of the systems and methods of the present invention which is given with reference to the several figures of the drawing, in which:

FIG. 1 is a functional block diagram of a PRIOR ART digital echo canceller employed to cancel acoustic cross-coupling echo components in a telephone appliance communication system;

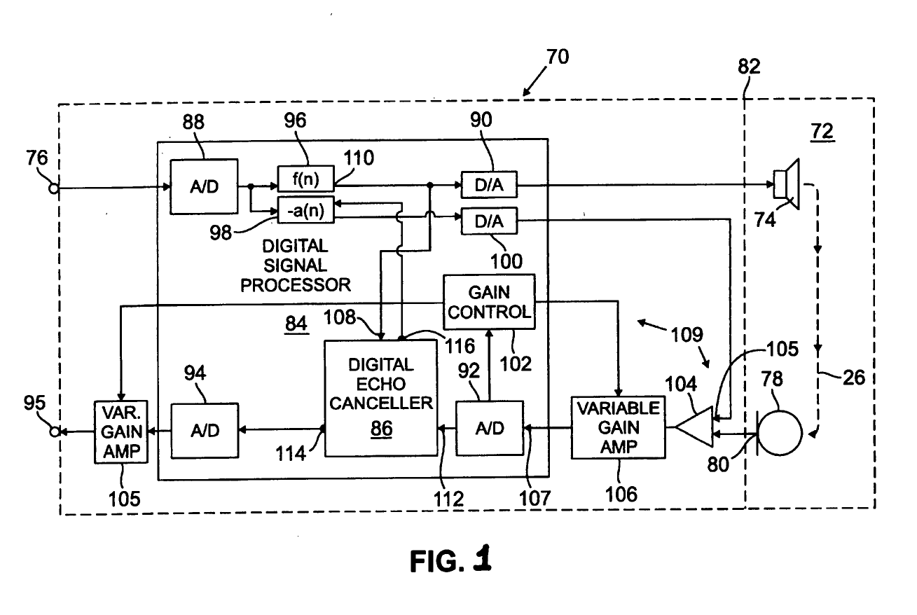

FIG. 2 is a functional block diagram of a first exemplary embodiment of an (a two-stage digital) echo canceller and receive-path distortion compensation according to the systems and methods of this invention;

FIG. 3 is a functional block diagram of a second exemplary embodiment of an echo canceller with receive-path compensation for loudspeaker distortion according to the systems and methods of this invention;

FIG. 4 is a functional block diagram of a third exemplary embodiment of an echo canceller of the present invention using a reference signal derived from a second microphone according to the systems and methods of this invention in a speakerphone telephone system;

FIG. 5 is a functional block diagram of a fourth exemplary embodiment of an echo canceller of the present invention using a reference signal derived from a second microphone according to the systems and methods of this invention in a speakerphone telephone system; and

FIG. 6 is a functional block diagram of a fifth exemplary embodiment of an (a two-stage digital) echo canceller of the systems and methods according to the invention using a reference signal derived from a second microphone and having receive-path distortion compensation.

### DETAILED DESCRIPTION

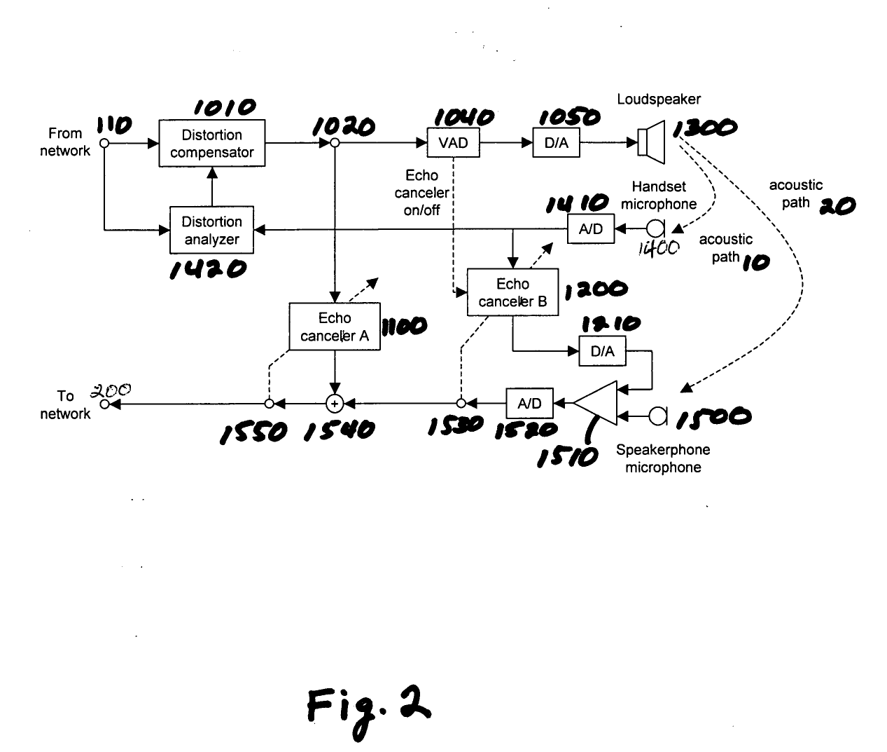

In FIG. 2, a signal from a far side, such as, for example, a network (not shown) is received at input terminal 110 and is received by distortion compensator 1010. Distortion compensator 1010 outputs a signal which, at node 1020, is directed to both echo canceller A 1100 and to voice activation detector (VAD) 1040. From the VAD 1040, the signal is output to digital-to-analog converter (D/A) 1050, and then to loudspeaker 1300. Voice activation detector (VAD) 1040 examines its incoming signal and determines if it contains significant energy and is likely to be speech rather than non-speech, for example, noise. The significance is determined by a configurable parameter as is known in the art. If the voice activation detector 1040 determines that the input signal contain speech, it outputs an “adapt” control signal to echo canceller B, 1200. If the input signal is determined not to contain speech, the voice activated detector 1040 outputs a “do not adapt” control signal to the echo canceller B, 1200. The purpose of the “do not adapt” control signal is to prevent adaptation of echo canceller B, 1200, in the absence of speech in the receive path from the network, 110. The purpose of echo canceller A, 1100 which may be, for example, a long-tail echo canceller, is to model the acoustic path between the loudspeaker and speakerphone microphone, while the purpose of echo canceller B, 1200 which may be, for example, a short-tail echo canceller, is to model the path between the handset microphone and speakerphone microphone.

After being converted to an analog signal in D/A converter 1050, the signal is emitted as sound by loudspeaker 1300, which may be, for example, a speakerphone loudspeaker or a handset speaker. The sound emitted by loudspeaker 1300 is detected by handset microphone 1400 via, usually, a relatively short direct acoustic path 10 between the loudspeaker 1300 and handset microphone 1400.

The sound emitted by loudspeaker 1300 is also detected by speakerphone microphone 1500 via a, usually, relatively longer direct acoustic path 20 as well as by a number of relatively long indirect acoustic paths. The signal generated by speakerphone microphone 1500 is amplified in summing amplifier 1510 as is an analog signal input to the summing amplifier 1510 from echo canceller B, 1200, when in operation, via digital to analog converter 1210. Summing amplifier 1510 outputs the sum of the speakerphone microphone output and the signal output by D/A converter 1210 from echo canceller B, 1200, if any. This summed signal is output by analog-to-digital converter 1520 to be adaptively applied to echo canceller B, 1200 via node 1530 and to be inputted to adder 1540 to be summed with the signal output by echo canceller A 1100.

A summed signal is output by adder 1540 to node 1550 after which it is adaptively applied to echo canceller A, 1100 and to codec 200 which is connected to a network (not shown).

The signal output from handset microphone 1400 is digitized by A/D converter 1410 and input to distortion analyzer 1420, which also receives far-end signals from network terminal 110. The distortion analyzer 1420 outputs a signal in the form of a control signal, which is applied to distortion compensator 1010 to reduce and/or eliminate distortion from the signal input to distortion compensator 1010 so that the signal to be output by distortion compensator 1010 has reduced distortion or no distortion.

The combination of analog-to-digital converter 1520, echo canceller B, 1200, the two inputs to echo canceller B, 1200, and the handset microphone 1400 is an analog subtraction circuit according to the systems and methods of this invention.

Advantages of this exemplary embodiment of the systems and methods according to this invention include effective and improved echo cancellation due to use of distortions from the speaker that are inherent in the reference channel of the first stage of the echo canceller, which comprises elements 1200, 1210, 1400, 1410, 1500 and 1510.

In FIG. 2, the distortion analyzer 1420 compares the far-end receive signal with the loudspeaker signal as detected by the handset microphone 1400. The distortion analyzer 1420 derives a measure of the distortion, which may or may not be present, and generates and sends a corrective signal to distortion compensator 1010. The distortion compensator 1010 provides a correction signal to the far-end signal to reduce distortion at the loudspeaker 1300.

In various exemplary embodiments of the systems and methods of the invention, the output of the distortion compensator 1010 is used to limit the maximum amplitude of the receive signal from the distortion compensator. Known distortion compensators, having various degrees of sophistication, may be used in this regard.

The analog output signal of the handset microphone 1400 is converted to a digital signal in A/D converter 1410 and that digital signal is fed to distortion analyzer 1420 to generate a control signal to apply to distortion compensator 1010, and is used for echo cancellation in echo canceller B 1200.

Echo canceller B, 1200 effectively models the acoustic path between the handset microphone 1400 and speakerphone microphone 1500, while not diverging significantly during periods of doubletalk.

Moreover, cancellation during the first stage of echo cancellation provides improved dynamic range at the A/D converter 1520 that receives the output of the summing amplifier 1510, thereby helping to reduce the occurrence of saturation at the A/D converter 1520 based on relatively loud signals received by the speakerphone microphone 1500.

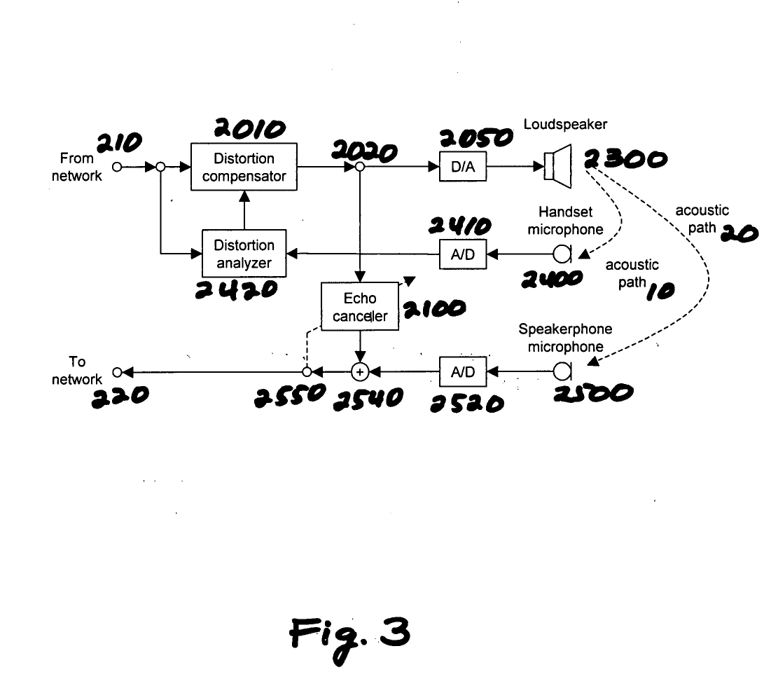

The exemplary embodiment of the systems and methods of this invention shown in FIG. 3 differs from the exemplary embodiment of FIG. 2 in that a VAD 1040 and echo canceller B, 1200 (and its output) are not employed. Thus, this exemplary embodiment is less complex than the system shown in FIG. 2.

Like the system shown in FIG. 2, the system shown in FIG. 3 reduces distortions from the loudspeaker 2300, which leads to more effective echo cancellation. The handset microphone 2400 is used as input to the receive-path distortion compensation mechanism. The output of the receive-path distortion compensation mechanism or subsystem feeds both the loudspeaker 2300 and the echo canceller 2100. In FIG. 3, the output from A/D converter 2520 is added to the echo cancellation signal generated by echo canceller 2100 at node 2540 and is subsequently sent to a network via codec 220, as well as to echo canceller 2100 via node 2550 to adaptively update echo canceller 2100.

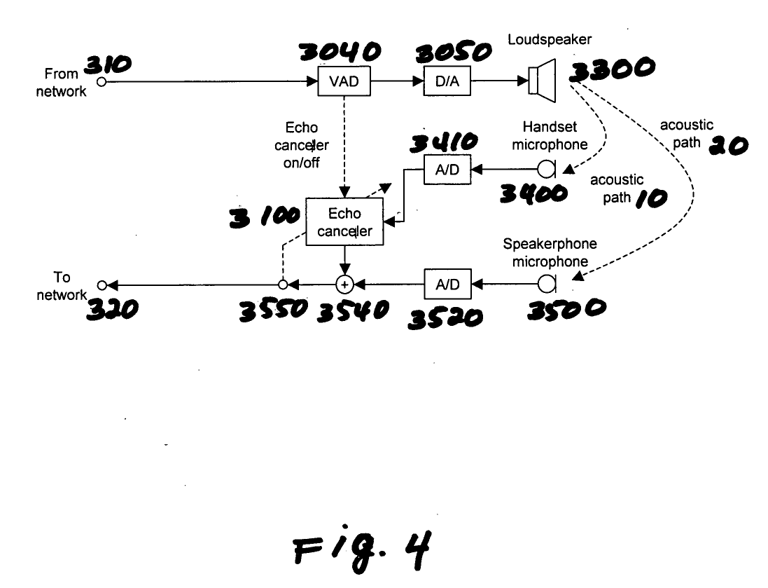

The exemplary embodiment of the systems and methods of this invention shown in FIG. 4 differs from the systems and methods according to the invention as shown in FIG. 2 in that (1) in FIG. 4, there is no distortion analyzer or distortion compensator, and there is one echo canceller 3100 that receives an output signal from the handset microphone 3400 as a reference for the single echo canceller 3100. Also, in FIG. 4, unlike in FIG. 2, there is no summer to add the speakerphone microphone output signal and an echo canceller signal prior to A/D 3520. Nevertheless, use of distortions from the loudspeaker are implicitly found in the reference channel of the echo canceller 3100, which are used to adjust, and effectively improve cancellation of the signal sent to the network (not shown) via codec 320.

Moreover, in the exemplary embodiment of FIG. 4, as in the exemplary embodiment FIG. 2, distortions from the loudspeaker inherent to the reference channel of the echo canceller, are used and lead to more effective echo cancellation. The signal output by the single echo canceller 3100 uses as a reference the signal through analog/digital converter 3410 provided by handset microphone 3400. Also, in FIG. 4, the output from A/D converter 3520 is added to the echo cancellation signal generated by echo canceller 3100 at node 3540 and is subsequently sent to a network via codec 320, as well as to echo canceller 3100 via node 3550 to adaptively update echo canceller 3100.

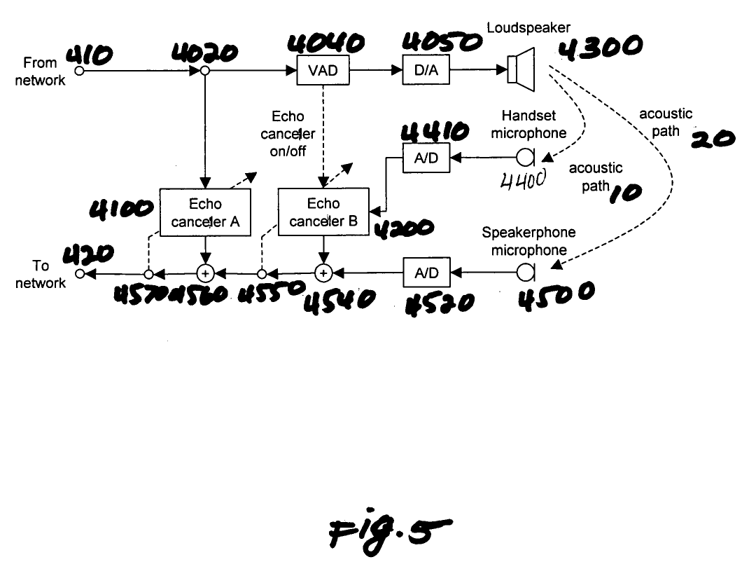

The exemplary embodiment of the systems and methods of this invention shown in FIG. 5 differs from the embodiment shown in FIG. 2 in that, in FIG. 5, there is no distortion analyzer or distortion compensator, and there is no analog summing of the speakerphone microphone output signal with an echo canceller signal. Additionally, in FIG. 5, the echo canceller 4200 is fed the output signal of only the handset microphone 4400.

In the exemplary embodiment of FIG. 5, as in the exemplary embodiment of FIG. 2, distortions from the loudspeaker are inherent to the reference channel of the echo canceller B 4200, which includes elements 4400, 4410, 4200, 4500, 4520 and 4540, leading to more effective echo cancellation. In the exemplary embodiment of FIG. 5, the echo canceller B, 4200 effectively models the acoustic path between the handset microphone 4400 and speakerphone microphone 4500, while not diverging significantly during periods of doubletalk. Additionally, the echo cancellation signal generated by echo canceller A, 4100 is summed at node 4560 with the signal output from summing node 4540, which is sent to codec 420 and, at node 4570, to adaptively update echo canceller A, 4100.

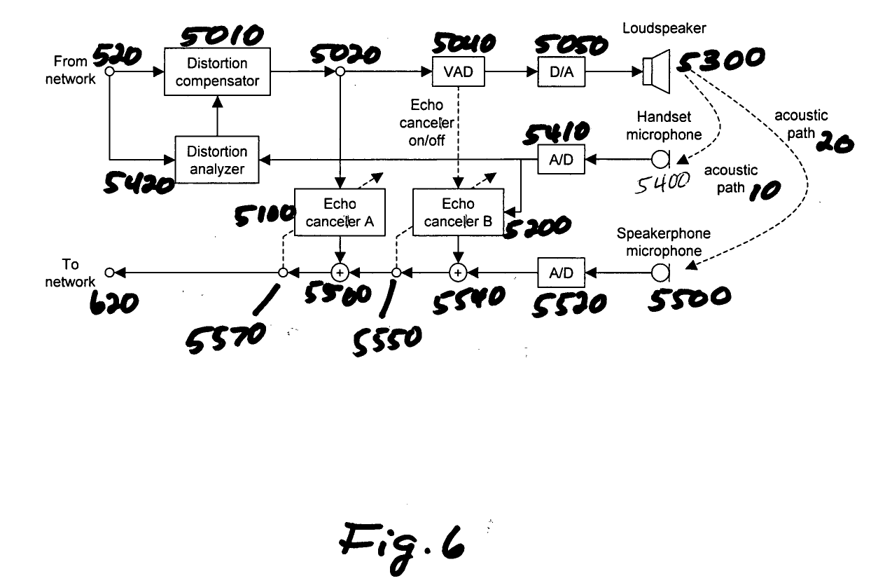

The exemplary embodiment of the systems and methods of this invention shown in FIG. 6 differs from the exemplary embodiment of FIG. 2 in that the signal output from the echo canceller B, 5200 is not summed with the signal provided by the speakerphone microphone 5500. However, distortions from the loudspeaker 5300 are implicit to the reference channel of the first-stage echo canceller B 5200, leading to more effective echo cancellation. Moreover, echo canceller B, 5200, which may be a short-tailed echo canceller, is adapted more slowly than echo canceller A, 5100, which may be a long-tailed echo canceller, effectively modeling the direct path between the speakerphone loudspeaker 5300 and speakerphone microphone 5500, including loudspeaker distortions, while not diverging significantly during periods of doubletalk.

Also, in the exemplary embodiment of FIG. 6, echo canceller B, 5200 receives its reference signal via handset microphone 5400 via A/D converter 5410 and echo canceller A 5100 receives its reference signal from the far-end receive signal as modified indirectly by A/D converter 5410, distortion analyzer 5420, and distortion compensator 5010. In the embodiment shown in FIG. 6, the error cancellation signal generated by echo canceller B, 5200 is fed directly to the summing node 5540, which sums the adaptive echo cancellation signal output by echo canceller B, 5200 with the signal generated by A/D converter 5520, and forwards the summed signal to summing node 5500, where is it combined with the output signal from echo canceller A, 5100. Echo canceller B, 5200 is adaptively updated by the signal output from node 5540 via node 5550, and echo canceller A, 5100 is adaptively updated by the signal output from summing node 5560 via node 5570.

Those skilled in the art who now have the benefit of the present disclosure will appreciate that the present invention may take many forms and embodiments. Some embodiments have been presented and described so as to give an understanding of the invention. It is intended that these embodiments should be illustrative, and not limiting of the present invention. Rather, it is intended that the invention cover all modifications, equivalents and alternatives falling within the spirit and scope of the invention as defined by the appended claims.

What is claimed is:

1. An method of echo cancellation by reducing direct coupling of a speakerphone loudspeaker to a speakerphone microphone for a speakerphone having a handset, comprising:
adaptively measuring an acoustic path from the handset microphone to the speakerphone microphone by generating a signal from the handset microphone;
adaptively generating an analog acoustic echo canceling signal using the signal generated by the handset microphone;
generating a speakerphone microphone signal; and
subtracting the analog acoustic echo canceling signal from the speakerphone microphone signal to modify the speakerphone output signal.

2. The method of claim 1, further comprising using a linear adaptive filter to adaptively generate the acoustic echo canceling signal.

3. The method of claim 1, further comprising measuring nonlinear distortions produced by the loudspeaker.

4. The method of claim 3, further comprising using the handset microphone to measure the nonlinear distortions produced by the loudspeaker.

5. The method of claim 3, further comprising using the measured nonlinear distortions to generate a distortion compensation signal to be applied to the loudspeaker.

6. The method of claim 1, wherein the measured acoustic path from the handset microphone to the speakerphone microphone comprises a direct acoustic path therebetween.

7. An echo cancellation system that reduces direct coupling of a speakerphone loudspeaker to a speakerphone microphone for a speakerphone having a handset, comprising:
a handset microphone used to adaptively generates a signal that provides a measure of an acoustic path from the handset to the speakerphone microphone;
a system element that adaptively generates an analog acoustic echo canceling signal using the signal generated by the handset microphone;
a speakerphone microphone that generates a signal; and
a system element that subtracts the analog acoustic echo canceling signal from the speakerphone microphone signal to modify the speakerphone output signal.

8. The system of claim 7, further comprising a linear adaptive filter to adaptively generate the acoustic echo canceling signal.

9. The system of claim 7, further comprising, a distortion analyzer that measures nonlinear distortions produced by the loudspeaker.

10. The system of claim 9, wherein the handset microphone provides a measure of nonlinear distortions produced by the loudspeaker.

11. The system of claim 9, further comprising a distortion compensator to use the measured nonlinear distortions to generate a distortion compensation signal to be applied to the loudspeaker.

12. The system of claim 7, wherein the measured acoustic path from the handset to the speakerphone microphone comprises a direct acoustic path therebetween.

13. A speakerphone, comprising:
a loudspeaker;
a speakerphone microphone;
a handset having a handset speaker and a handset microphone used to adaptively generates a signal that provides a measure of an acoustic path from the handset to the speakerphone microphone;
first means for adaptively generating an analog acoustic echo canceling signal using the signal generated by the handset microphone; and
second means for subtracting the analog acoustic echo canceling signal from the speakerphone microphone signal to modify the speakerphone output signal.

14. The speakerphone of claim 13, further comprising a linear adaptive filter to adaptively generate the acoustic echo canceling signal.

15. The speakerphone of claim 13, further comprising, a distortion analyzer that measures nonlinear distortions produced by the loudspeaker.

16. The speakerphone of claim 15, wherein the handset microphone provides a measure of nonlinear distortions produced by the loudspeaker.

17. The speakerphone of claim 15, further comprising a distortion compensator to use the measured nonlinear distortions to generate a distortion compensation signal to be applied to the loudspeaker.

18. The speakerphone of claim 15, wherein the measured acoustic path from the handset to the speakerphone microphone comprises a direct acoustic path therebetween.
